(19) United States
(12) Patent Application Publication
(10) Pub. No.: US 2006/0282330 A1
(43) Pub. Date: Dec. 14, 2006

(54) Method and system for outsourced RFID labeling and tracking

(76) Inventors: Christopher Frank, Karlsruhe (DE); Bernd Seeburger, Bretten (DE)

Correspondence Address: NATH & ASSOCIATES, 112 South West Street, Alexandria, VA, 22314, US

(21) Appl. No.: 11/148,435

(22) Filed: Jun. 9, 2005

(51) Int. Cl. G06Q 20/00; H04L 9/00; G06G 1/12; G06G 1/14; G06Q 10/00

(52) U.S. Cl. 705/22; 713/151; 705/20; 705/21; 705/23; 705/28

(57) ABSTRACT

Methods for outsourced radio frequency identification (RFID) labeling and tracking comprising the steps of providing a managed central server unit for handling and processing RFID label data and/or tracking data of labeled goods, whereas the central server unit can be remotely accessed by users via local clients; providing connecting means connecting the central server unit to RFID label printing devices at the users' facilities and/or connection means connecting the central server unit to RFID data reading devices located at the users' and/or their business partners' facilities at points of interest; handling and coordinating communications between the central server unit and the printing devices and/or the central server unit and the reading devices by the central server unit and controlling processes of the printing devices and/or the central server unit directly or indirectly by the central server unit, whereas the mentioned communications and process are remotely initiated by the users via the clients; handling and coordinating communications between the central server unit and the reading devices by the central server unit and controlling processes of the central server unit and/or the reading devices directly or indirectly by the central server unit, whereas the mentioned communications and processes are remotely initiated by the users via the clients; as well as systems and computer program products for realizing these methods.

This invention relates to a method and a system for outsourced radio frequency identification (RFID) labeling and tracking.

### BACKGROUND OF THE INVENTION

RFID technique becomes more and more common in industrial or commercial identification and tracking of goods or parts. In particular, in connection with the usage of RFID chips as carriers of additional information like packaging details, transport details etc. Therefore, many customers require the suppliers to provide RFID labels on shipped goods. Sometimes even the possibility of tracking of the labeled goods is required. And the numbers of customers using and requiring these technologies grows every day.

However, the provision of RFID labels containing individual data and also the tracking of goods carrying these labels cannot be easily realized. Firstly, there is an investment barrier, as costly hardware is required. Moreover, the technology requires specific knowledge, costly maintenance and manpower.

For that reason, many companies, and especially small entities which perhaps only need small numbers of RFID labels, have problems to meet the requirements of their customers.

Consequently, there is a need for a method which offers a cost efficient possibility to provide RFID labels on goods also to suppliers who are in need of only a rather small number of RFID labels or who just want to have a minimum of usage and maintenance efforts. This is particularly the case for small entities or suppliers who want to supply the RFID technology only for a few of their products.

Moreover, there is also a need for a method that offers a cost efficient possibility of providing a RFID based tracking system for goods or products to the mentioned group of suppliers.

Furthermore, there is a need for systems able to realize the described methods.

### SUMMARY OF THE INVENTION

The methods and systems for outsourced RFID labeling and tracking in accordance with the present invention address the mentioned needs and offers the possibility, in particular to small entities, to provide RFID labels on their shipments and/or products and/or to provide a RFID based tracking system for these goods or products without requiring investments in costly hardware, specific knowledge, costly maintenance and additional manpower.

The method for outsourced RFID labeling according to the invention, comprises the steps of providing a managed central server unit for handling and processing RFID label data, whereas the central server unit can be remotely accessed by users via local clients; providing connecting means connecting the central server unit to RFID label printing devices located at the users' facilities; handling and coordinating communications between the central server unit and the printing devices by the central server unit and controlling processes of the printing devices and/or the central server unit directly or indirectly by the central server unit, whereas the mentioned communications and processes are remotely initiated by the users via the clients.

The method for outsourced RFID tracking according to the invention comprises the steps of providing a managed central server unit for handling and processing RFID label data and tracking data of labeled goods, whereas the central server unit can be remotely accessed by users via local clients; providing connecting means connecting the central server unit to RFID data reading devices located at the users' and/or their business partners' facilities at points of interest; handling and coordinating communications between the central server unit and the reading devices by the central server unit and controlling processes of the central server unit and/or the reading devices directly or indirectly by the central server unit, whereas the mentioned communications and processes are remotely initiated by the users via the clients.

The system for outsourced RFID labeling according to the invention comprises a managed central server unit remotely accessible for users via local clients; RFID label printing devices located a the users' facilities; lines and/or a network architecture via which a connection between the central server unit and the printing devices can be established; a user interface engine for providing user interfaces allowing the users to initiate via the clients processes at the central server unit and/or at at least one of the printing devices and/or to initiate data transfer between the central server unit and at least one of the printing devices.

The system for outsourced RFID tracking according to the invention comprises a managed central server unit remotely accessible to users via local clients; RFID data reading devices located at the users' and/or their business partners' facilities at points of interest; lines and/or a network architecture, via which a connection between a central server unit and the reading devices can be established; a user interface engine for providing user interfaces allowing the users to initiate via the clients processes at the central server unit and/or at at least one reading device and/or to initiate data transfer between the central server unit and at least one reading device.

In a further aspect of the invention said needs are satisfied by a computer program product for outsourced RFID labeling, which is embodied on a machine-readable medium and comprises instructions for managing a central server unit; instructions for handling and processing RFID label data on the central server unit; instructions for providing to users remote access to the central server unit via local clients; instructions for transferring data between the central server unit and RFID label printing devices via connecting means; instructions for handling and coordinating communications between the central server unit and the printing devices by the central server unit and for controlling processes of the printing devices and/or the central server unit directly or indirectly by the central server unit; and instructions for initiating the mentioned communications and processes remotely by the users via the clients.

Yet another aspect of the invention is formed by a computer program product for outsourced RFID tracking, which is embodied on a machine-readable medium and comprises instructions for managing a central server unit; instructions for handling and processing RFID label data and tracking data of labeled goods; instructions for providing to users remote access to the central server unit via local clients; instructions for transferring data between the central server unit and RFID data reading devices via connecting means; instructions for handling and coordinating communications between the central server unit and the reading devices by the central server unit and for controlling processes of the reading devices and/or the central server unit directly of indirectly by the central server unit; instructions for initiating mentioned communications and processes remotely by the users via the clients.

The described methods, systems and computer program products provide an implementation of RFID data processing without requiring costly hardware investments, as the invention relies on providing external services which can be accessed remotely using the internet or other communication networks or network architectures. An RFID client is provided, which is easy to install and to handle and which is connected to a central service system that provides RFID data, or tracking data respectively, to the concerned clients or devices. In this way the user can avoid costly hardware investment and maintenance efforts, as the invention supports minimized RFID hardware on the users' side. In principle, methods, systems and computer program products can be build on the ground of the present invention which require only reading and/or printing devices and at least one client at the users' side, whereas any communication and process initiation is performed in the central server unit upon the client's request.

In an improvement of the method according to the invention the method steps for outsourced RFID labeling and outsourced RFID tracking are combined, so that both services can be offered. In an advantageous embodiment of the method according to the invention the method comprises steps of running user interfaces, particularly graphical user interfaces, for remotely accessing the central server unit via the clients or for initiating communications and/or processes on the central server unit. This so-called server-centric embodiment of the invention further reduces maintenance efforts at the users' side, so that the client is left to run only hardware devices related tasks or processes. The users can concentrate on their usual business while all integration, maintenance and controlling is external done at the central server unit.

However, the described server-centric method or mode cannot be applied if dial-up networks are used for server-client communication. If such dial-up connections or proxy-enabled networks are used for example in local area networks (LAN) or wide area networks (WAN), server to client process initiations are impossible due to dynamically provided IP-addresses or because the server cannot reach the concerned client computer via the proxy-server.

Therefore, in another embodiment of the method according to the invention the method comprises a step of running on the clients user interfaces, particularly graphical user interfaces, for remotely accessing the central server unit via the clients or for initiating communications and/or processes. In this way also dial-up networks or networks incorporating proxy-servers can be used. The central server unit only provides services requested from the client, while the client locally runs all user interfaces and dialogs and transmits only data entered in the user interfaces by the users to the central server unit. Central server unit internally creates, possibly after initiating an evaluating internal processes, response messages and transmits them to the client. The client then displays the results to the user and/or initiates further processes of devices connected to the client or invokes additional user interfaces.

In an improvement of the method according to the invention the step of at least partly accessing the central server unit using a secure or encrypted communication protocol, particularly a https protocol, is provided. In this way intrusions of third parties into the data transfer can be prevented.

Another advantageous embodiment of the method according to the invention comprises the step of creating within the central server unit billing information for each communication and/or process initiated by the user according to the content of the initiated communication or process. With the help of these billing information it is possible to bill only the performed processes or communications to the user or customer, so that the billing amount corresponds directly to the extent of usage of the central server unit and the offered services. Obviously, also user-specific configurations, like user-specific prices or fees etc, can additionally or alternatively be taken into account for the creation of billing information.

In another embodiment of the method according to the invention the handling and coordinating of communications, the controlling of processes and the initiating of processes and/or communications comprise the further steps of initiating a process or a communication by a user via a client by requesting a desired service or information; transferring this request to the central server unit using a certain transmission protocol, preferably the ebXML protocol; authenticating the requesting user; invoking at least one process at the central server unit in correspondence with the made request; transferring results of this at least one process to the concerned clients and/or printing and/or reading devices using a certain transmission protocol, preferably the ebXML protocol; invoking at the concerned clients and/or printing and/or reading devices processes in accordance with the results of the at least one central server unit process, in particular display and/or printing and/or reading processes. In this way communications and processes can be handled, coordinated and initiated efficiently.

An improved method according to the invention further comprises the step of automatically configuring clients in reaction to a request to the central server unit. This offers the possibility of an automatic self-configuration of the clients when connected to the central server unit for the first time. In this way a further reduction of installation efforts can be achieved. Moreover, also the possibility of updating the configuration automatically is given, so that maintenance efforts can also be reduced.

An advantageous embodiment of the system according to the invention combines the features of the systems for outsourced RFID labeling and of outsourced RFID tracking, so that both RFID related services can be provided with a single system.

In another embodiment of the system according to the invention the central server unit and/or the clients and/or the reading devices and/or the printing devices comprise encryption and/or decryption means for sending and/or receiving data via a secure or encrypted communication protocol, in particular a https protocol. This makes it possible to use a communication protocol which is protected against intrusion of non-authorized persons.

In yet another embodiment of the system according to the invention the central server unit comprises a gateway, preferably an ebXML gateway, for parsing and/or verifying the content of data streams reaching the central server unit via the lines or a network architecture and/or for client authentication. This offers the possibility of recognizing and authorizing the user behind the client and further stabilizes the transmission of data by the verification of the contents of data streams.

In a further embodiment of the system according to the invention the central server unit comprises a service handling device, a processing control unit and a queue, whereas the processing control unit and the queue can be accessed by the service handling device. This offers an efficient and fast handling of data, as available data is stored in the queue and can be directly accessed by the service handling device. Instead, if the requested information is not available in the queue, the service handling device will access the processing control unit and request the required processing result. In this was it is avoided to perform the same processes several times again within a short period of time.

An improved system according to the invention comprises a user interface engine, particularly a graphical user interface (GUI) engine, for providing a requested user interface or dialog to the user via the client. This offers to the user a convenient way to communicate with the central server unit or to invoke or request processes or communications. Especially graphical user interfaces offer an instructive way of entering data or requesting communications or processes.

In a further advantageous embodiment of the system according to the invention the central server unit comprises a data control unit which is capable of relational data based management system (RDBMS) functionality. In this way an enhanced extent of data integrity, persistency and transactional safety can be achieved.

In a specific embodiment of the system according to the invention the at least one client comprises a service handling device capable of creating communication or process initiation messages, preferably with the help of a gateway, and/or of generating a digital signature for authentication purposes. The provision of this service handling device makes it possible to realize an efficient data and process handling within the client and provides a unified interface to all units in the client application.

In another embodiment of the system according to the invention a gateway is provided in at least one client, preferably an ebXML gateway, for parsing the central server unit's response to communication or process initiation messages and/or verifying the contents of these messages and invoking corresponding processes by passing on received data to a service handling device. In this way data integrity can be enhanced so that incorrect data do not cause processing load in the client.

In yet another embodiment of the system according to the invention at least one client is provided with a printing device interface and/or a reading device interface, to which printing and/or reading devices can be connected. In this way printing and/or reading devices can be connected to the client so that no additional connections to the network architecture have to be provided. This is necessary, if dial-up connections or proxy-servers are used in the network architecture, so that printing or reading devices cannot be addressed directly by the central server unit. Therefore, if the system according to the invention is run in the client-centric mode, such device interfaces have to be provided.

In an improved embodiment of the computer program product according to the invention instructions are provided which create within the central server unit billing information for each communication and/or process initiated by the user according to the content of the initiated communication of process. With the help of these billing information it is possible to bill only the performed processes or communications to the user or customer, so that the billing amount corresponds directly to the extent of usage of the central server unit and the offered services. Obviously, also user-specific configurations, like user-specific prices or fees etc, can additionally or alternatively be taken into account for the creation of billing information.

In another embodiment of the computer program product according to the invention the instructions for handling and coordinating communications, the instructions for controlling processes and the instructions for initiating processes and/or communications comprise instructions for initiating the process or communication by a user via a client by requesting a desired service or information; instructions for transferring this request to the central server unit using a certain transmission protocol, preferably the ebXML protocol; instructions for authenticating the requesting user; instructions for invoking at least one process corresponding to the made request at the central server unit; instructions for transferring results of this at least one process to the concerned clients and/or printing and/or reading devices using a certain transmission protocol, preferably the ebXML protocol; instructions for invoking at the concerned clients and/or printing and/or reading devices processes in accordance with the results of the at least one central server unit process, in particular display and/or printing and/or reading processes. In this way communications and processes can be handled, coordinated and initiated efficiently.

### BRIEF DESCRIPTION OF THE DRAWINGS

FIG. 1: Preferred embodiment of a combined system according to the invention for outsourced RFID labeling and tracking.

FIG. 2: Detailed view of a central server unit of a system according to the invention.

FIG. 3: Detailed view of an embodiment of a client being part of a system according to the invention.

FIG. 4: Schematic illustration of an embodiment of a method according to the invention.

FIG. 5: Application of the method of FIG. 4 for performing a configuration update of a client.

FIG. 6: Server-centric print process sequence in accordance with the invention.

FIG. 7: Client-centric print process sequence.

FIG. 8: Server-centric read process sequence.

FIG. 9: Client-centric read process sequence.

### DESCRIPTION OF PREFERRED EMBODIMENTS

In the following, the invention is explained in more detail with the help of preferred embodiments of the invention, whereas these embodiments are not to restrict the scope of the patent, but are intended to illustrate the invention. Identical reference numbers are used for the same parts or items throughout the following text passages.

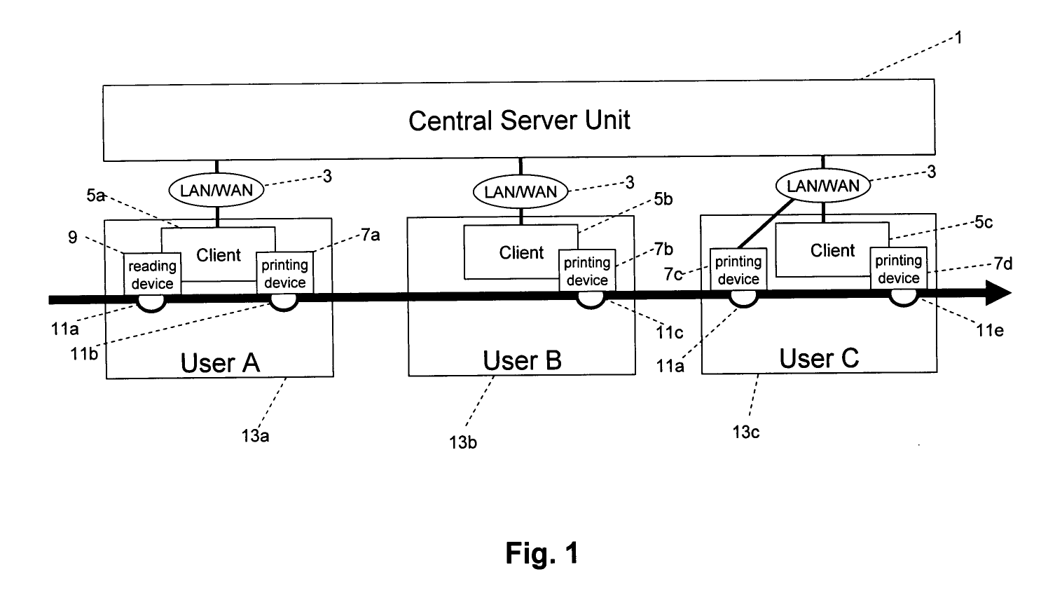

FIG. 1 schematically shows a preferred embodiment of a system according to the invention suited for outsourced RFID labeling as well as for outsourced RFID tracking. As shown in FIG. 1, the system according to the invention comprises a managed central server unit 1 which is connected to clients and devices via a network architecture 3, which might be a local area network (LAN) or a wide are network (WAN) as exemplary indicated in FIG. 1. The central server unit 1 is owned by a kind of provider which is responsible for accessibility, administration and maintenance of the central server unit 1.

The users, or customers respectively, at their end have ready to operate hardware, in particular clients 5a, 5b, 5c and/or reading devices 9 or printing devices 7a, 7b, 7c, 7d. The clients 5a, 5b, 5c are connected to the central server unit 1 via the network architecture 3, so that the central server unit 1 is remotely accessible for user via these local clients 5a, 5b, 5c.

As far as the printing and/or reading devices are concerned, these might be directly connected to the central server unit 1 via the network architecture, as indicated in the case of the printing device 7c. However, they might also be connected to the central server unit via the network architecture 3 and one of the clients 5a, 5b, 5c, as it is the case for the printing and reading devices 7a, 7b, 7d and 9. In the latter case the concerned clients 5a, 5b and 5c have to be regarded as being part of the network architecture 3. Consequently, a connection between the central server unit 1 and the printing devices 7a, 7b, 7c, 7d or the reading devices 9 can be established via a network architecture including one of the clients 5a, 5b, 5c or not including such a client.

As illustrated in FIG. 1, there might be different users 13a, 13b, 13c connected to the central server unit 1 at the same time, whereas they can make use of the central server unit separately and independently, or they might communicate with each other via the central server unit 1.

As it is indicated by points of interest 11a, 11b, 11c, 11d and 11e in FIG. 1, users A, B and C 13a, 13b, 13c have installed reading and/or printing devices at point of interests at their facilities. In this way they are able to print RFID labels within their facilities at those points, where they need them and when they need them without having to deal with the problems discussed above. The underlying data transfer to the concerned printing devices and vice versa is realized via the mentioned network architecture 3 and, possibly, clients. On the other hand, such a data transfer can also be realized between reading devices and the central server unit, whereas the reading devices are located at points relevant for the tracking and tracing of the goods labeled with RFID chip comprising labels.

Of course, it is also possible to realize data transfer between devices or clients of different users. For example, a RFID reading device might be located at the store house of a freight forwarding company and another one at the point of receipt of goods of a customer, so that the user of the system as well as its customer are capable of determining the location of a shipment at each point of time.

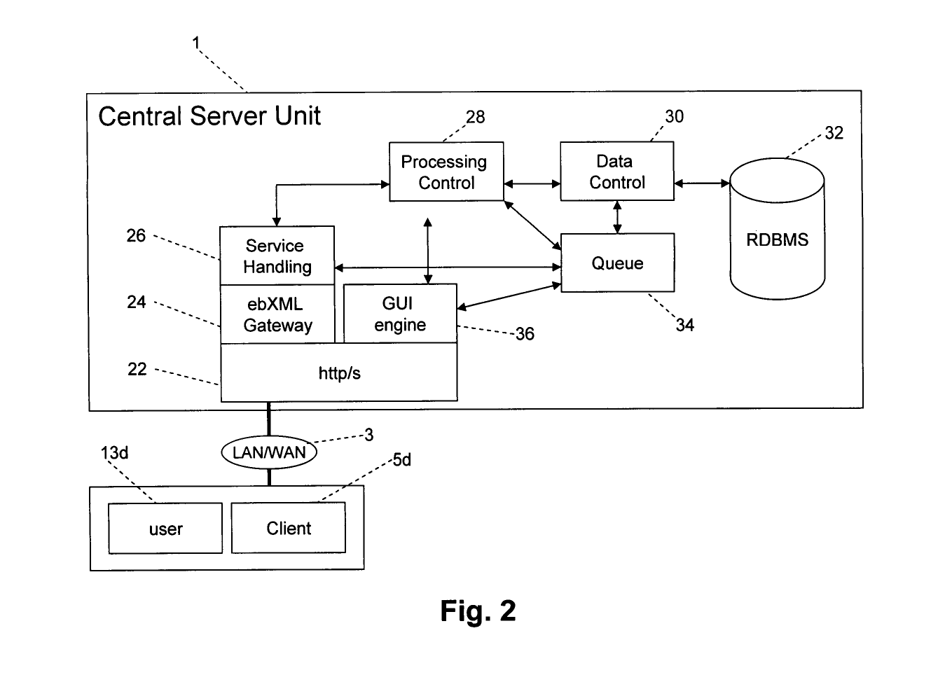

FIG. 2 schematically shows the central server unit 1 of an embodiment of a system according to the invention in more detail. For the reason of simplicity only one user 13d is shown, whereas the client 5d located at this user 13d is connected to the central server unit 1 via the network architecture 3. Obviously, also a greater number of users, or clients or printing or reading devices respectively, could be connected to the central server unit 1.

As can be seen, the central server unit 1 depicted in FIG. 2 is provided with encryption and/or decryption means 22, as indicated exemplary by the short cut for a secure hyper text transfer protocol http/s. In this way a secure information transfer between the central server unit and the clients or printing or reading devices can be realized in both directions or just in one or the other direction, as it is required in the specific case.

Moreover, a gateway 24, in this specific embodiment an electronic business extended markup language (ebXML) gateway is provided. This gateway receives incoming data from the encryption and/or decryption means 22, parses the data, verifies it and passes it on to a service handling device 26.

In an advantageous embodiment of the invention the gateway 24 is also used for examining the user permissions of the user requesting any services, communications or data from the central server unit 1. The client authentication is also performed by the gateway 24, whereas this authentication might be realized by the verification of a digital signature.

Being invoked by the gateway 24 the service handling device handles and coordinates the performing of the processes requested by the client 5d, or the user 13d respectively, by either activating the processing control unit 28, which is connected to the data control unit 30 and the queue 34, in order to generate process results being not available yet, or by directly accessing the queue 34 in case that the required data is already waiting there.

However, which data is available in the queue 34 is also controlled by the processing control unit 28, which is able to interact with the queue 34 as well as with the data control unit 30, whereas this data control unit 30 has access to a relational data base management system (RDBMS) 32. In this constellation the data control unit 30 maintains the data base connection and ensures data integrity, persistency and transactional safety making use of the RDBMS functionality. Furthermore, the data control unit ensures data separation of the costumers' data contents. For efficiency reasons, also a connection between the data control unit 30 and the queue 34 might be provided as depicted in FIG. 2.

Obviously, also another data base system than a RDBMS could be provided, for example a sequential data base system.

As can be seen, the central server unit 1 of FIG. 2 comprises a user interface engine, more precisely a graphical user interface (GUI) engine, for providing user interfaces, particularly graphical user interfaces, or dialogs to the user 13d via the client 5d. This GUI engine makes it possible to run the system in the server-centric mode explained above. Nevertheless, the user interfaces can also be run completely on the clients in another embodiment of the invention.

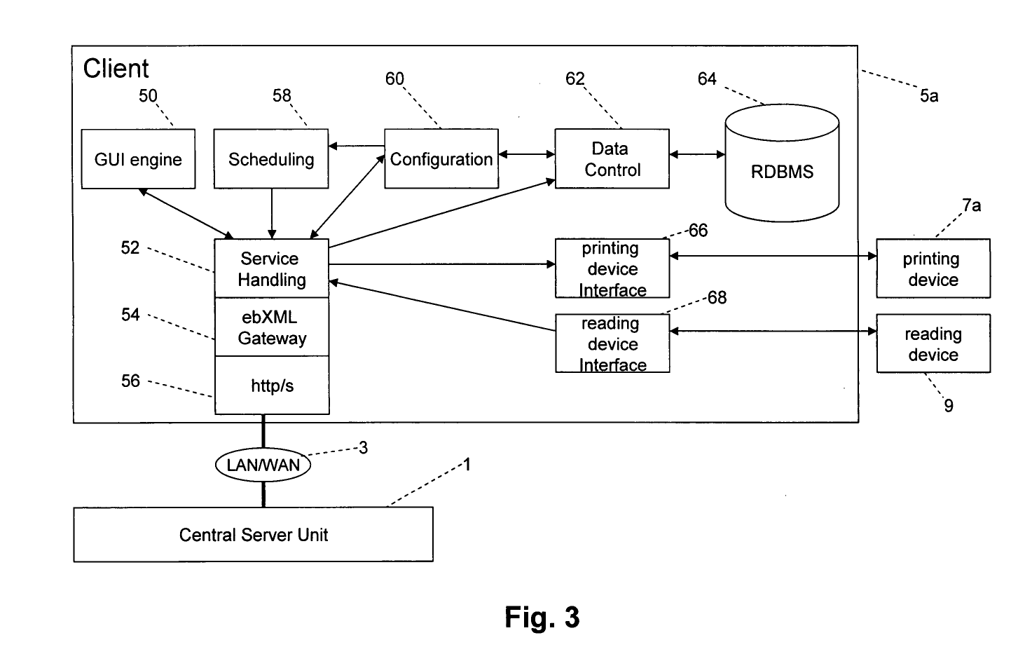

The scheme given in FIG. 3 shows in a more detailed way the client 5a of FIG. 1. Similar to the central server unit 1 of FIG. 2 the client 5a also comprises encryption and/or decryption means 56. Analogously to the gateway 24 in FIG. 2 the client 5a also comprises a gateway, and in particular an ebXML gateway responsible for the encoding of communication messages in the required language, in this case the ebXML-language.

As in the case of the central server unit 1 depicted in FIG. 2 a service handling device 52 is provided which communicates again with configuration means 60 and data control means 62, whereas the data control means 62 once again provide the connection to a RDBMS 64, which forms the storage of the client 5a. Obviously, instead of a RDBMS also other data base systems, like sequential data base systems could be provided. Moreover, also file systems used for hard disks or floppy disks or other storage media can be used, as in most applications only smaller data amounts have to be stored on the clients' side for fallback reasons and user convenience, while the larger data amounts are usually stored on the central server unit in order to realize a centralized data storage.

In case of the client 5a also a printing device interface 66 as well as a reading device interface 68 are provided, both being able to communicate with the service handling device 52. These devices 66 and 68 serve as interfaces for the printing device 7a and the reading device 9, which are not directly connected to the central server unit 1, but via the client 5a which in this respect forms a part of the network architecture.

Additionally, the client 5a depicted in FIG. 3 comprises a GUI engine 50 similar to the GUI engine of the central server unit depicted in FIG. 2. Again, a user interface engine would also be sufficient. However, a graphical user interface is obviously much more convenient and instructive for the users.

The provision of this GUI engine 50 within the client 5a might be necessary in case of the usage of a dial-up connection or proxy-server for the reasons explained above. If no such dial up connection or proxy-server is used, it is advantageous not to provide such a GUI engine 50 within the client 5a in order to minimize maintenance efforts at the user's side and to reduce application complexity.

The client of the system according to the invention is always the initiator of a communication or process and makes it possible to receive data synchronously on the same communication session between the client and the central server unit, whereas this communication session has been opened by the client.

Usually, communications and processes will often be performed regularly, i.e. in accordance with a certain schedule. For this reason an advantageous embodiment of the system according to the invention comprises scheduling means 58 which get their configuration from configuration means 60. The scheduling means then request the generation of a request message from the service handling device 52, which will internally create the according ebXML message or communication by requesting an adequate message/service request composition from the ebXML gateway 54. This ebXML gateway 54 also generates the digital signature utilized to authenticate the requesting client 5a at the central server unit.

The encryption and/or decryption means 56 provide the encryption of the request message so that it can be transferred via the network architecture 3 to the central server unit 1. A response to the request is advantageously received synchronously on the same session. The ebXML gateway 54 will then parse the received content, will verify this content and invoke the adequate processes by passing on the received data stream to the service handling device 52, which has originally requested the initial central server unit process.

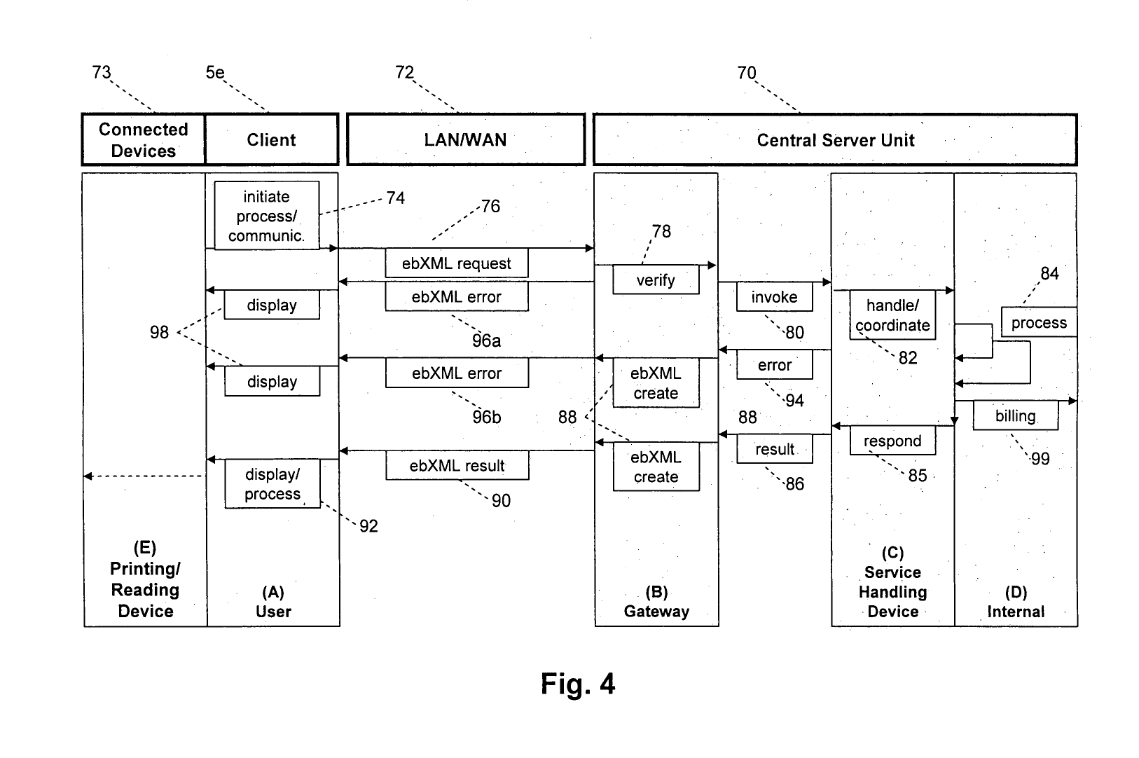

FIG. 4 schematically shows a preferred embodiment of the method according to the invention. As depicted, it comprises the providing 70 of a managed central server unit for handling RFID label data and/or tracking data of labeled goods. Moreover, connecting means are provided which connect the central server unit to RFID label printing or reading devices, as it is illustrated by the provision 72 of connection means in form of LANs or WANs and by the provision 73 of connected devices. As explained above, the provision 73 of connection means realizing connected devices might include the client 5e, if the printing or reading devices are connected to the LAN/WAN via the client, as it is necessary in case of dial-up connections or the usage of proxy server.

In the method according to the invention a process or communication is initiated 74 by the user via the client 5e. Such a process or communication might be initiated by a GUI. In this case the user will request the process or communication for example by clicking a button within the GUI or dialog. On the other hand, in case of a reader-event, the processor communication will be initiated upon a so called reading event message generated by the reading device.

The wished process/communication is then requested 76 via connection means, or more precisely the LAN/WAN, using the ebXML protocol for data transfer to the central server unit. In an advantageous embodiment of the invention the transferred request will additionally contain authentication information, so that the central server unit, or precisely the gateway, can parse the made request and verify the user permissions and the syntax of the request. If an error occurs during this processes within the gateway an ebXML error message can optionally be created and transferred 96a to the user and be optionally displayed 98 to him.

After the parsing and verifying of the request corresponding processes are invoked 80 within the central server unit. In the following, the service handling device handles and/or coordinates 82 the communications and processes. Again, in case of an occurring error an error message is generated 94, translated into ebXML 88 and transferred 96b to the user where it is displayed 98.

Further on, the required processes are performed 84 internally in the central server unit. The obtained results are then responded 85 and the results are transferred to the gateway, where the plain responses are translated 88 into ebXML.

In the following, the results are transferred 90 in an encoded way to the user, where a communication is displayed 92 or processes in accordance with the obtained results are performed 92.

The mentioned processes that would have to be performed in accordance with the obtained results might for example include the printing of RFID labels on printing devices which are provided 73 as connected devices, or also the commencing of internal processes of the clients 5e.

Preferably, communications or messages containing process control information are transferred 90 to the user or the client 5e respectively within the same session initiated 74 by the corresponding request, i.e. synchronously. Also error messages 96a, 96b are preferably transferred synchronously.

After completion of internally performed 84 processes billing information is created 99 internally within the central server unit. In this way billing data is generated in accordance with the performed processes, so that these processes can be billed to the user.

It is worth mentioning that the transferred 90 result might also be just a pure acknowledgement signal acknowledging receipt of an initiated 74 communication or the performing 84 of an initiated 74 process.

The method schematically depicted in FIG. 4 in course of elapsing time t can be used as common processing sequence that underlies other processing sequences used for different communications, processes or communications.

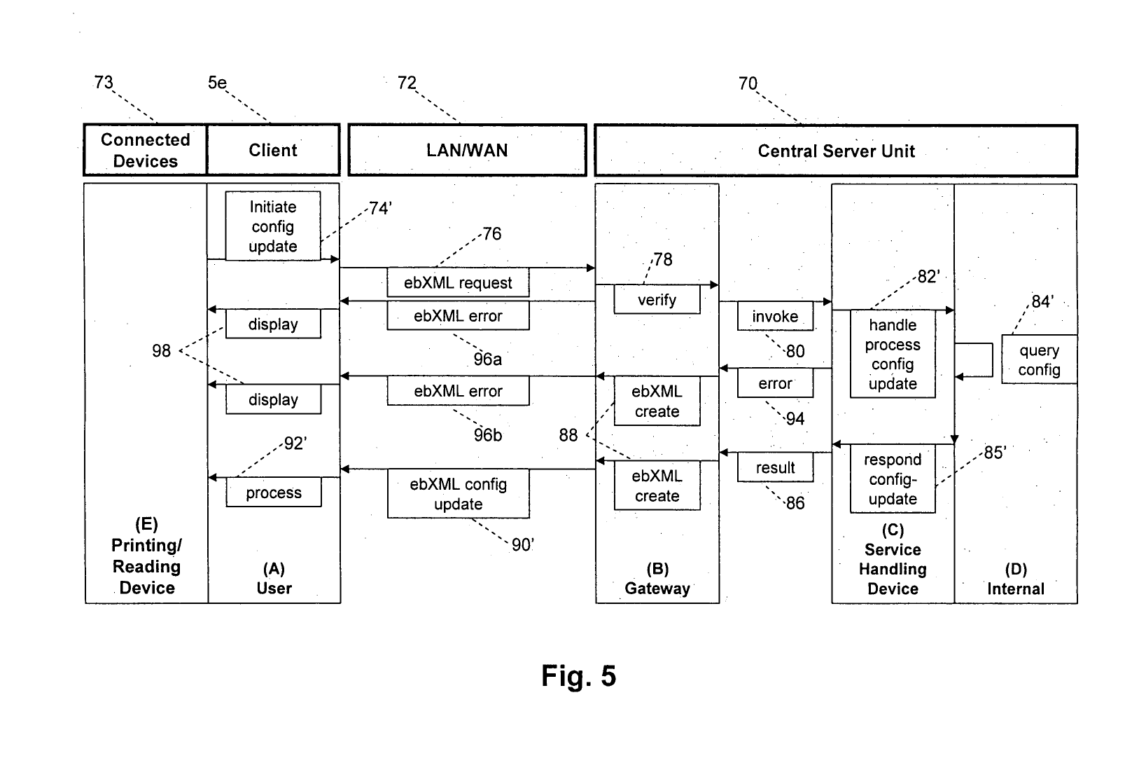

An example for applying the common processing sequence or method of FIG. 4 is the performing of a configuration update of a client as it is depicted in FIG. 5. Obviously the schematic drawing is rather similar to the one of FIG. 4. The process initiated is now the update of the configuration. This initiated 74′ process is treated in the same way as explained in connection with FIG. 4. Consequently, the service handling device handles 82′ the process of configuration update and requires from the central server unit to query 84′ the actual configuration.

In turn, the necessary configuration update is responded 85′. This result is transferred 86 to the gateway where it is translated into ebXML, as it is already known from FIG. 4. In the following, the encoded configuration update is transferred 90′ to the user, or client 5e respectively. As a result of the transferred configuration update a process of updating the user client 5e is performed 92′ within the client. Processes of the printing or reading devices are not performed in this specific example.

The processing sequence of FIG. 5 might for example be used to configure the system according to the invention. For example, each time the client 5e is started a configuration update might be initiated automatically. Alternatively, an configuration update could also be initiated periodically, whereas this periodic initiation might be realized with the scheduling means 58 shown in FIG. 3.

Configuration data kept up to date by a system configuration process shown in FIG. 5 might for example be server addresses under which the client 5e tries to reach the central server unit, server downtime schedules informing the client 5e about times when the server is not reachable due to maintenance or for other reasons, common server messages such as newsletters, common account information or other news in human readable form or user related server messages which relate to the specific user, for example personal account information, invoices or other human readable texts.

In another application of the common processing sequence of FIG. 4 tracking data of goods is communicated to the client 5e instead of configuration update data. In this way the user behind the client can be informed about the actual status and location of single RFID labeled goods, whereas tracking and tracing data of these goods is kept within the central server unit analogously to the configuration in FIG. 5, so that this tracking and tracing data can, analogously to querying 84 configuration data, be queried from the central server unit and transferred 85, 86, 88, 90 to the client, or user respectively.

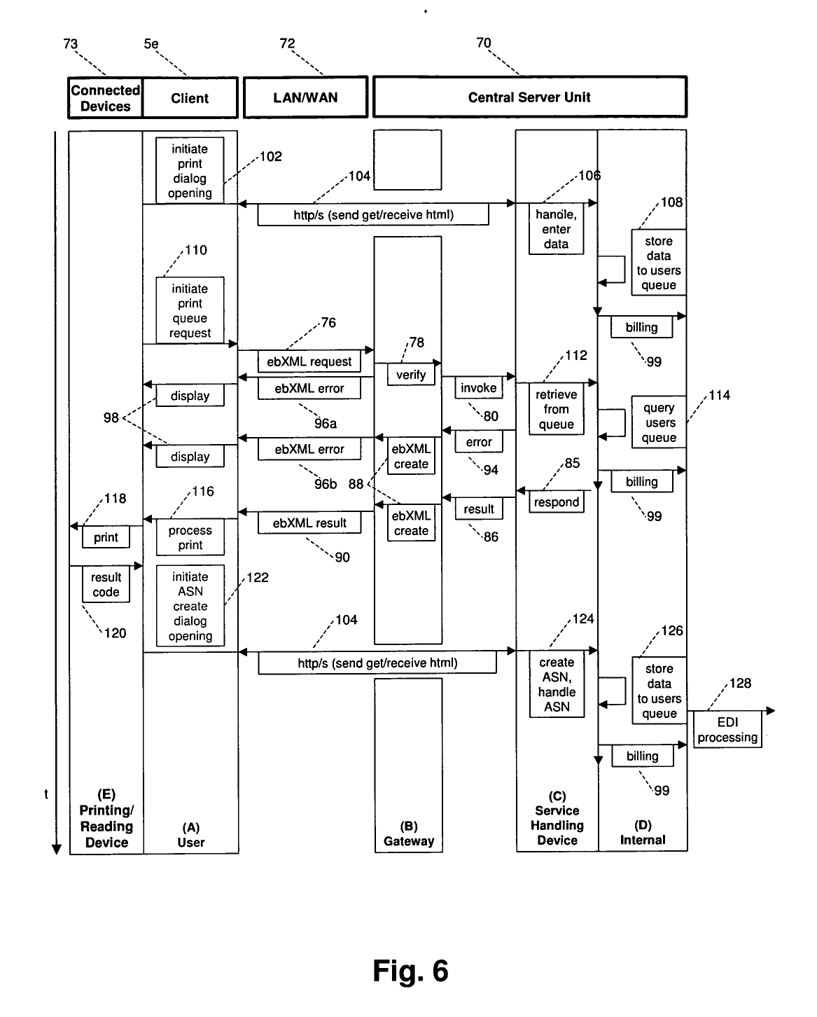

FIG. 6 shows a server-centric print process sequence in accordance with the invention. The processing sequence starts with initiating 102 the opening of a print dialog run on the central server unit. This dialog is preferably a graphical user interface as discussed above. Entering of data in the print dialog, or data transfer in general, is in this case realized by transferring 104 data via a secure communication protocol through the LAN/WAN. The transferred data is consequently entered in the print dialog in the central server unit and also handled therein. Further on, corresponding data is stored 108 to the queue of the user that has initiated the opening of the print dialog. Moreover, billing information is created 99 for this process.

The entered data might be for example the identification number of the article labels should be printed for, the required number of labels to print, shipment information, shipping codes or other additional information. The handling 106 of the data also comprises the generation of a print command which will be stored 108 in the users' queue for the purpose of submission to the concerned printing device later on.

From this point on, the common processing sequence known from FIGS. 4 and 5 is used, whereas the initiated 110 process is a print queue request. This request is transferred to the central server unit in the way described above and error handling is performed as explained in connection with FIGS. 4 and 5. As a result of the transferred print queue request the retrieving of data from the users' queue is handled/coordinated 112 within the central server unit. This handling and coordinating results in querying 114 the users' queue for data, or in this case print commands, related to the user that has initiated 110 the print queue request. The print command or print data forms the result that is responded 85, translated and transferred 86, 88, 90 in the known manner to the client 5e or the concerned user respectively. Furthermore, billing information is created 99 for the made request.

As a result of the transferred print command, which might consist of 0 or more print command messages, a print process is performed 116 within the client, which controls, for example via a printing device interface a printing device, as it is schematically indicated in FIG. 2. The printing device then executes 118 the print command and prints the desired label. It is worth remembering, that the printing device can also be connected to the central server directly via the network architecture, as it is the case for the printing device 7c shown in FIG. 1. In this case the encoded result would have been directly transferred 90 to the printing device, which then performs 116 the print process and executes 118 the print command.

In a preferred embodiment of FIG. 6 the printing device transfers 120 after completion of the printing process a result code to the client 5e, what leads to the initiating 122 of the opening of an advanced shipment note (ASN) creation dialog. The corresponding data is again transferred to the central server unit via a secure communication protocol, as indicated by the http/s protocol. The dialog itself is again run on the central server unit and the transferred 104 data is entered 124 in the dialog run as user interface on the central server unit. The transferred data is also handled 124 in the central server unit what might result in the storation of data 126 to the queue of the user that initiated 122 this process. Moreover, also the generation of an ASN business document and electronic transmission of this document to trading or business partners by means of electronic data interchange (EDI) processing 128 is possible. Applicable EDI transmission methods are for example WAN or AS2. For the generation of the ASN relevant data is required from the queue of the user who initiated the ASN creation.

Finally, billing information for this processes is created 99 again.

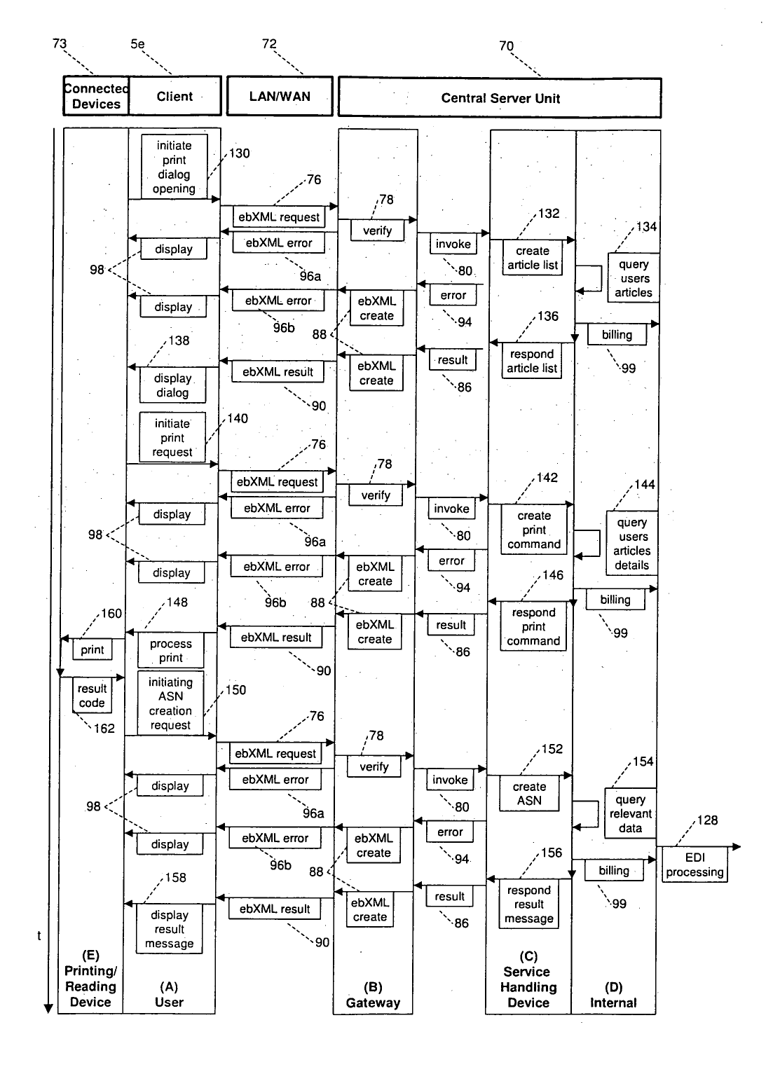

FIG. 7 schematically shows the process sequence of a client centric print process. As can be seen, this process sequence basically consists of three common process sequences similar to the one discussed in FIG. 4, which are performed one after another. However, the three parts differ in the kind of request that is made. In the first part the opening of a print dialog is initiated 130, in the second part a print request is initiated 140 and in the third part, an ASN creation request is initiated 150. Although different processes or communications are initiated in the three parts so that different data is transferred, the same reference numbers are used for transfer steps and error handling in order to obtain a more instructive illustration. Steps with significant differences, however, are referenced with different numbers.

The processing sequence starts with the initiating 130 of the opening of a print dialog. As dialogs or graphical user interfaces are run on the client 5e in client-centric mode, the print dialog is opened on client 5e, whereas it might be advantageous to display the GUI contents of the last session as preselected values. However, actual article or product data has to be requested from the central server unit. For that reason, the client 5e simultaneously initiates a request to the central server unit for getting an update of the articles or products. This request is passed on to the central server unit and verified 78 therein as described in connection with FIG. 4. Also the error treatment has already been described above.

The next step worth being described is the handling and coordinating 132 of the creation of the article list update. As a result of this handling and coordinating step the article data of the user that has initiated 130 this process is queried 134, whereas a list of articles is generated containing the article identification numbers and the article names of all the articles that have been changed since the last article list update request. If no such article exists, an empty result list is generated.

Further on, billing information is created 99 for the performed processes and the generated article list is responded 136 as a result. In the following, this result forming article list is transferred to the client 5e in the manner described in connection with FIG. 4. The client 5e receives the article list, updates the contents of the print request GUI dialog and displays 138 this dialog. The user can now enter the data for the print request, which might be the same as mentioned in connection with the server-centric print process sequence, for example the identification number of the article labels shall be printed for etc. The entering of data can be, at least partly, realized by selecting articles labels shall be printed for from the article list received as described above.

Once the correct data is entered, the user initiates 140 via the client 5e the print request. As a consequence, translation and extension of the selected articles and other required data into a printer command is requested from the central server unit. For this purpose, the entered data is transmitted to the central server unit in the way already described in connection with FIG. 4. Once again the error treatment is again performed in the same way as explained in connection with FIG. 4. The next relevant step covers the handling and coordination of the creating 142 of the required print command. As a result of this handling and creation step 142 details on concerned articles are internally queried 144 in the central server unit. If necessary, also information about the concerned business partners and other relevant data might be queried. The resulting data is put together and translated into a print command which is responded 146 in the following.

The responded print command is then transferred to the client 5e in the way described in connection with FIG. 4. Receiving the print command the client 5e performs 148 a print process by transferring the command to the local printing device where the print command is executed 160. The printing device transfers 162 a result code, for example in case it runs out of paper, a label jam occurs, the process has been executed without any error, etc. to the client 5e. Depending on this result code the client 5e may reset the printing process in order to allow the user to repeat the printing, or the printing command respectively.

Depending on the preferences of the system an ASN sending confirmation dialog might be displayed to the user. If desired, the user can within this GUI element request the generation of an ASN business document and the electronic transmission of this document to its trading or business partner. If the user decides to do so, an ASN creation request is initiated 150. This request is transferred to the central server unit in the usual way. The creation of the ASN document is then handled and coordinated 152 within the central server unit.

As a result of this handling and coordinating 152, relevant data, for example business relation or business rules for the creation of the ASN, are internally queried 154 from the central server unit and combined with the print command information in order to create an ASN document in accordance with the guidelines of the destination business partner. Afterwards, an EDI processing of the ASN is performed 128, i.e. the ASN document is transmitted to the business partner using an EDI transmission method, for example VAN or AS2.

Further on, billing information is created 99 for the requested process. Moreover, a result message is responded 156 to the client 5e in the usual way, which might include information about the transmitted ASN business document, for example time of sending, etc.

Receiving the responded 156 result message, or the transferred 90 ebXML result, the client 5e displays 158 the result message to the user within an adequate GUI element run on the client 5e. Optionally, a copy of the received message might be stored on the local file store.

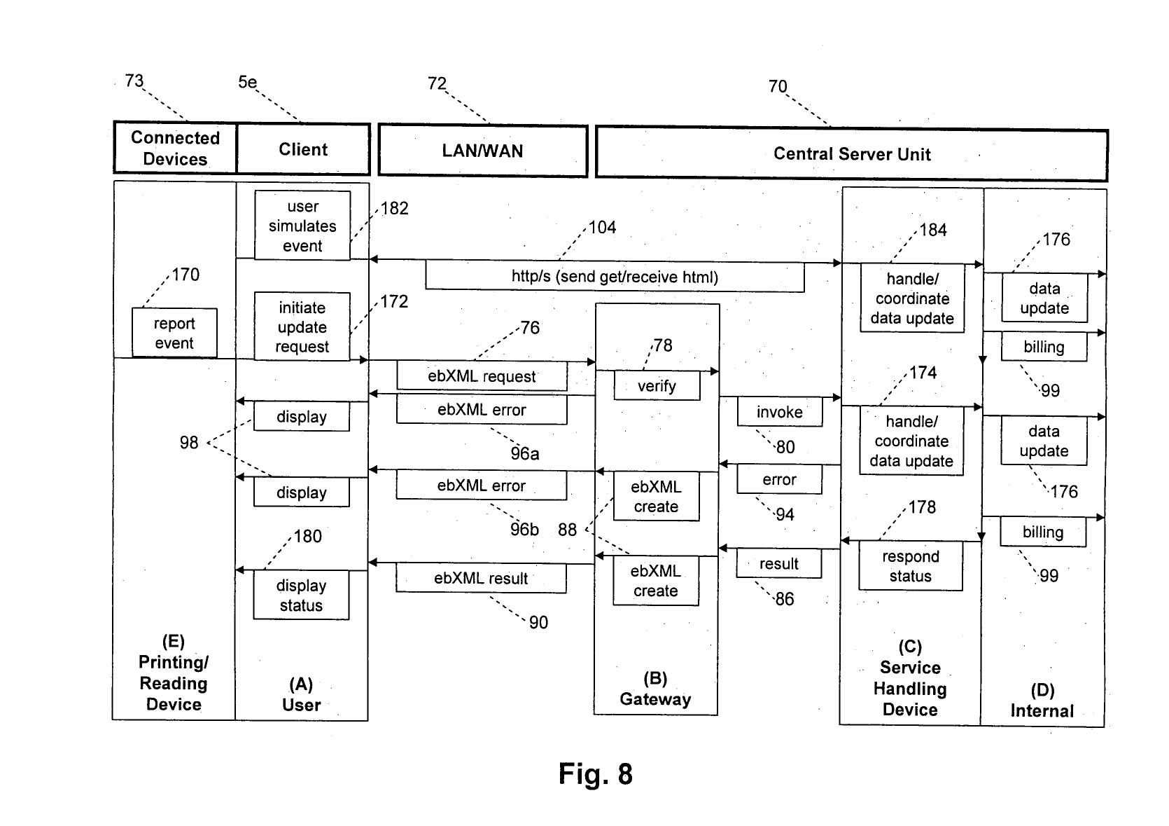

FIG. 8 schematically illustrates a server-centric read process sequence in accordance with the invention. This process sequence covers the usage of a RFID reading device located at a point of interest, the reporting of an event or so called reading event, i.e. one or more RFID labels or tags which are in the range of the antenna of the reading device at the moment, and the processing of the data on the central server unit.

If the user wants to manually transmit tag or label travelling information, i.e. change of location, to the central server unit, this can be realized with the help of an optional so called simulated reading event. Such a simulated reading event is available via a simulation dialog GUI element. In this way, tracing and tracking data of labeled goods or tags can be manually manipulated.

As depicted in the read process sequence of FIG. 8, a data update due to a reading event can be achieved in two ways:

Firstly, a reading device connected to the client 5e is reporting 170 a reading event, i.e. a tag or label in the range of antenna. Furtheron, an update request is initiated 172. Then the request is transferred to the central server unit in the way described in connection with FIG. 4, where the handling/coordinating 174 of a data update is invoked. Error treatment is realized in the same way as described in connection with FIG. 4.

As a result of the handling and coordinating 174 of the data update an internal data update is performed 176 with in the central server unit.

Billing information for the initiated processes and communications is created 99 and a status is responded 178 to the client 5e informing the user about the success of the tracking data update. This status is transferred to the client as a result in the way described in connection with FIG. 4. Receiving this transferred result, or status respectively, the client 5e displays 180 this received status to the user.

The second way to realize a data update is that the user simulates 182 a reading event of a reading device. For this purpose the opening of a simulation GUI element on the central server unit is initiated on the client 5e, what is in FIG. 8 regarded as being part of simulating the reading event 182. The central server unit consequently opens such a GUI dialog for event simulation, what is in FIG. 8 regarded as being part of handling and coordinating 184 data update. Within this GUI dialog the user is presented a set of reading devices and a list of articles known to the central server unit in connection with the user that simulates 182 the reading event. The user can now manipulate the displayed data by transferring 104 data via a secure communication protocol. After data has been manipulated the data update is handled/coordinated 184 what results in the performing 176 of an internal data update within the tracking database of the client server unit. Finally, billing information for the performed process and/or communications is created 99.

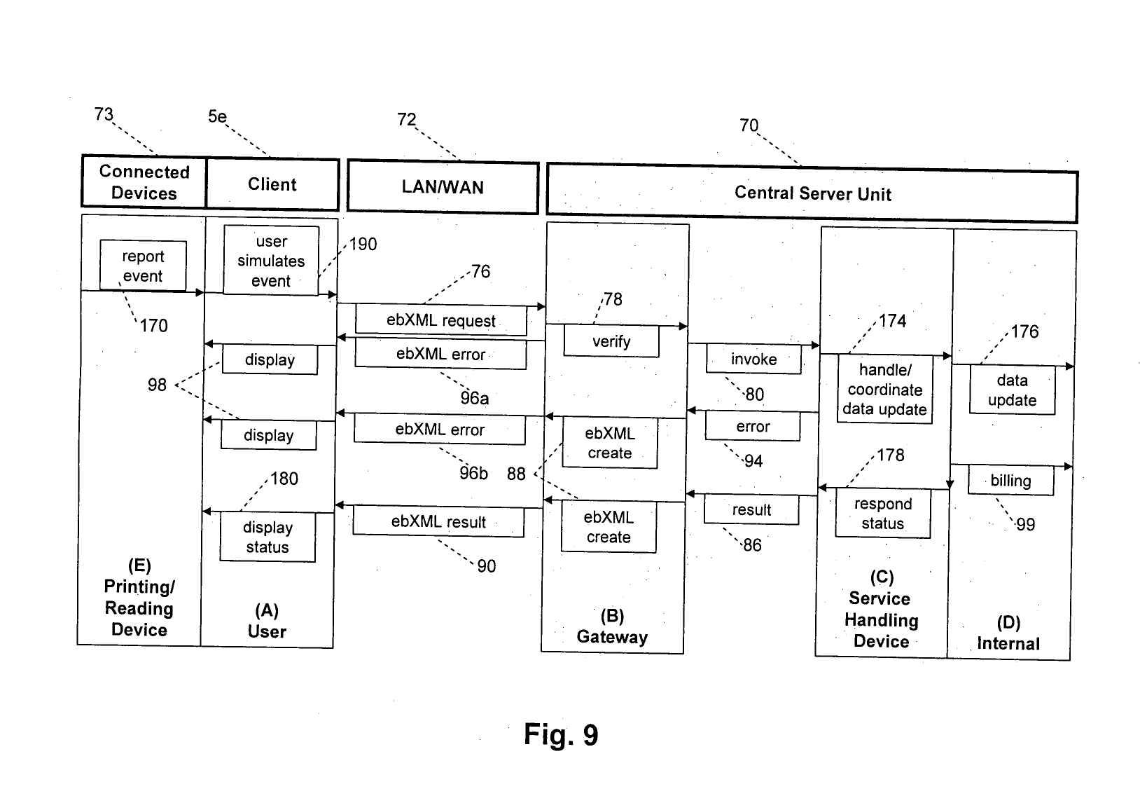

FIG. 9 schematically illustrates the client-centric read process sequence. As in case of the server-centric read process sequence also two possibilities of realizing a data update exists:

In the first possibility the reading device reports 170 a reading event. In this case things are the same as in the server-centric read process sequence. An update request is initiated (not depicted in FIG. 9), which is transferred to the central server unit, where the handling and coordinating of data update 174 is performed, resulting in the data update 176 of the tracking data base. The other aspects of the processing sequence in this case are also the same as in the server-centric read process sequence.

In a second possibility the user again simulates 19 a reading event. This time, however, this is done by running a simulation GUI element on the client 5e. Within this GUI element the user enters or selects the data he wants to manipulate. If this is completed, it makes no difference, whether the movement information for a product or good originates from the reading device or the simulation GUI element. Therefore, the manipulated data can be transferred to the central server unit pretending that it is data of a reading device. Consequently, from this point on the same processing sequence is used as in the case of an reading event reported 170 by the reading device.

### LIST OF REFERENCE NUMBERS

1 central server unit
3 network architecture
5a client
5b client
5c client
5d client
5e client
7a printing device
7b printing device
7c printing device
7d printing device
9 reading device
11a point of interest
11b point of interest
11c point of interest
11d point of interest
11e point of interest
13a user A
13b user B
13c user C
22 encryption and/or decryption means
24 ebXML gateway
26 service handling device
28 processing control unit
30 data control unit
32 relational database management system
34 queue
36 GUI engine
50 GUI engine
52 service handling device
54 ebXML gateway
56 encryption and/or decryption means
58 scheduling means
60 configuration means
62 data control means
64 relational database management system
66 printing device interface
68 reading device interface
70 provide central server unit
72 provide connection means (LAN/WAN)
73 provide connected devices
74 initiate process/communication
76 request process/communication using ebXML
78 parsing and verifying request
80 invoke corresponding processes
82 handle/coordinate processes/communications
84 perform required processes
85 respond result
86 transfer result to gateway
88 translate response into ebXML
90 transfer encoded result to user
92 display communication/perform according processes
94 generate error message (optional)
96 transfer error message to user
98 display error message (optional)
99 create billing information
t time
74′ initiate configuration update
82′ handle the process of configuration update
84′ query actual configuration
85′ respond necessary configuration upate
90′ transfer encoded configuration update
92′ perform process of updating user client
102 initiate opening of print dialog
104 data transfer via secure communication protocol
106 enter/handle data in user interface run on central server unit
108 store data to user's queue
110 initiate print queue request
112 handle/coordinate retrieving data from user's queue
114 query user's queue
116 perform print process
118 execute print command
120 transfer result code
122 initiate opening of ASN creation dialog
124 enter/handle data in user interface
126 store date to user's queue
128 EDI processing of ASN
130 initiate opening of print dialog
132 handle/coordinate article list update
134 query user's article data
136 respond article list
138 display dialog
140 initiate print request
142 handle/create print command
144 query user's articles details and relevant information
146 respond print command
148 perform print process
150 initiate ASN creation request
152 handle/coordinate creation of ASN
154 query relevant data
156 respond result message
158 display result message
160 execute print command
162 transfer result code
170 report reading event
172 initiate update request
174 handle/coordinate data update
176 perform data update
178 respond status
180 display status
182 simulate reading event
184 handle/coordinate data update
190 simulate reading event

1. Method for outsourced radio frequency identification (RFID) labeling comprising the steps of
Providing (70) a managed central server unit (1) for handling (82) and processing (84) RFID label data, whereas the central server unit (1) can be remotely accessed (74, 76, 78) by users (13a, 13b, 13c) via local clients (5a, 5b);
Providing (72) connecting means (3) connecting the central server unit to RFID label printing devices (7a, 7b, 7c, 7d) located at the users' facilities;
handling and coordinating (82) communications between the central server unit (1) and the printing devices (7a, 7b, 7c, 7d) by the central server unit (1) and controlling (84) processes of the printing devices (7a, 7b, 7c, 7d) and/or the central server unit (1) directly or indirectly by the central server unit (1), whereas the mentioned communications and processes are remotely initiated (74) by the users (13a, 13b, 13c) via the clients.

2. Method for outsourced RFID tracking comprising the steps of:
providing (70) a managed central server unit (1) for handling (82) and processing (84) RFID label data and tracking data of labeled goods, whereas the central server unit (1) can be remotely accessed (74, 76, 78) by users (13a, 13b, 13c) via local clients (5a, 5b);
providing (72) connecting means (3) connecting the central server unit (1) to RFID data reading devices (9) located at the users' and/or their business partners' facilities at points of interest (11a, 11b);
handling and coordinating (82) communications between the central server unit (1) and the reading devices (9) by the central server unit (1) and controlling (84) processes of the central server unit (1) and/or the reading devices (9) directly or indirectly by the central server unit (1), whereas the mentioned communications and processes are remotely initiated (74) by the users (13a, 13b) via the clients (5a, 5b).

3. Method for outsourced RFID labeling and tracking comprising the steps of claim 1.

4. Method according to claim 1 further comprising the step of running user interfaces, particularly graphical user interfaces, for remotely accessing (74, 76, 78) the central server unit (1) via the clients (5a, 5b) or for initiating (110) communications and/or processes on the central server unit (1).

5. Method according to claim 1 further comprising the step of running on the clients user interfaces, particularly graphical user interfaces, for remotely accessing (74, 76, 78) the central server unit (1) via the clients or for initiating (110) communications and/or processes.

6. Method according claim 1 further comprising the step of at least partly accessing (104) the central server unit using a secure or encrypted communication protocol, in particular a https protocol.

7. Method according to claim 1 further comprising the step of creating (99) within the central server unit billing information for each communication and/or process initiated (74; 110) by the user (13a, 13b) according to the content of the initiated (74; 110) communication or process.

8. Method according to claim 1, wherein the handling and coordinating (82) of communications, the controlling (84) of processes and the initiating (74; 110) of processes and/or communications comprise the following:
initiating (74; 110) a process or a communication by a user (13a, 13b) via a client (5a, 5c) by requesting (76) a desired service or information;
transferring (76) this request to the central server unit (1) using a certain transmission protocol, preferably the ebXML protocol;
authenticating (78) the requesting user (13a, 13b);
invoking (80) at least one process at the central server unit (1) corresponding to the made request;
transferring results (86) of this at least one process to the concerned clients (5e) and/or printing and/or reading devices (7a, 7c, 9) using a certain transmission protocol, preferably the ebXML protocol;
invoking (92) at the concerned clients (5e) and/or printing (7a, 7c) and/or reading devices (9) processes in accordance with the results of the at least one central server unit process, in particular display and/or printing and/or reading processes.

9. Method according to claim 8, further comprising the step of automatically configuring clients in reaction to their request to the central server unit.

10. System for outsourced RFID labeling, comprising:
a managed central server unit (1) remotely accessible for users via local clients (5a, 5b, 5c);
RFID label printing devices (7a, 7b, 7c, 7d) located a the users' facilities;
lines and/or a network architecture (3) via which a connection between the central server unit (1) and the printing devices (7a, 7b, 7c, 7d) can be established;
a user interface engine (50; 36) for providing user interfaces allowing the users (13a, 13b, 13c) to initiate via the clients (5a, 5b, 5c) processes at the central server unit (1) and/or at at least one of the printing devices (7a, 7b, 7c, 7d) and/or to initiate data transfer between the central server unit (1) and at least one of the printing devices (7a, 7b, 7c, 7d).

11. System for outsourced RFID tracking, comprising:
a managed central server unit (1) remotely accessible to users via local clients (5a, 5b, 5c);
RFID data reading devices (9) located at the users' and/or their business partners' facilities at points of interest (11a, 11d, 11e);
lines and/or a network architecture (3), via which a connection between a central server unit (1) and the reading devices (9) can be established;
a user interface engine (50, 36) for providing user interfaces allowing the users to initiate via the clients processes at the central server unit (1) and/or at at least one reading device (9) and/or to initiate data transfer between the central server unit (1) and at least one reading device (9).

12. System for outsourced RFID labeling and tracking, comprising the features of claims 10.

13. System according to claim 10, wherein the central server unit (1) and/or the clients (5a, 5b, 5c) and/or the reading devices (9) and/or the printing devices (7a, 7b, 7c, 7d) comprise encryption and/or decryption means (22) for sending and/or receiving data via a secure or encrypted communication protocol (22), in particular via a https protocol (22).

14. System according to claim 10, wherein the central server unit (1) comprises a gateway (24), preferably an ebXML gateway (24), for parsing and/or verifying the content of data streams reaching the central server unit (1) via the lines or a network architecture (3) and/or for client authentication.

15. System according to claim 10, wherein the central server unit (1) comprises a service handling device (26), a processing control unit and a queue, whereas the processing control unit and the queue can be accessed by the service handling device (26).

16. System according to claim 10, wherein the central server unit (1) comprises a user interface engine (36), particularly a graphical user interface (GUI) engine (36), for providing a requested user interface or dialog to the user (13d) via the client (5d).

17. System according to claim 10, wherein the central server unit (1) comprises a data control unit (30) capable of relational database management system (RDBMS) functionality.

18. System according to claim 10, wherein at least one client (5a) comprises a service handling device (52) capable of creating communication or process initiation messages, preferably with the help of a gateway (54), and/or of generating a digital signature for authentication purposes.

19. System according to claim 10, wherein a gateway (54) is provided in at least one client, preferably an ebXML gateway (54), for parsing the central server unit's (1) response to communication or process initiation messages and/or verifying the contents of these messages and invoking corresponding processes by passing on received data to a service handling device (52).

20. System according to claim 10 wherein at least one client (5a) is provided with a printing device interface (66) and/or a reading device interface (68), to which printing (7a) and/or reading devices (9) can be connected.

21. Computer program product embodied on a machine-readable medium for outsourced RFID labeling comprising:
instructions for managing a central server unit (1);
instructions for handling and processing RFID label data on the central server unit (1);
instructions for providing to users remote access to the central server unit (1) via local clients (5a, 5b, 5c);
instructions for transferring data between the central server unit (1) and RFID label printing devices (7a, 7b, 7c, 7d) via connecting means (3);
instructions for handling and coordinating communications between the central server unit and the printing devices by the central server unit and for controlling processes of the printing devices and/or the central server unit directly of indirectly by the central server unit;
instructions for initiating the mentioned communications and processes remotely by the users via the clients.

22. Computer program product embodied on a machine-readable medium for outsourced RFID tracking comprising:
instructions for managing a central server unit;
instructions for handling and processing RFID label data and tracking data of labeled goods;
instructions for providing to users remote access to the central server unit via local clients;
instructions for transferring data between the central server unit and RFID data reading devices via connecting means;
instructions for handling and coordinating communications between the central server unit and the reading devices by the central server unit and for controlling processes of the reading devices and/or the central server unit directly or indirectly by the central server unit;
instructions for initiating mentioned communications and processes remotely by the users via the clients.

23. Computer program product according claim 21 further comprising instructions creating within the central server unit billing information for each communication and/or process initiated by the user according to the content of the initiated communication or process.

24. Computer program product according to claim 21, wherein the instructions for handling and coordinating communications, the instructions for controlling processes and the instruction for initiating processes and/or communications comprise the following:
instructions for initiating the process or communication by a user via a client by requesting a desired service or information;
instructions for transferring this request to the central server unit using a certain transmission protocol, preferably the ebXML protocol;
instructions for authenticating the requesting user;
instructions for invoking at least one process corresponding to the made request at the central server unit;
instructions for transferring results of this at least one process to the concerned clients and/or printing and/or reading devices using a certain transmission protocol, preferably the ebXML protocol;
instructions for invoking at the concerned clients and/or printing and/or reading devices processes in accordance with the results of the at least one central server unit process, in particular display and/or printing and/or reading processes.
